(19) United States
(12) Patent Application Publication
(10) Pub. No.: US 2024/0037148 A1
(43) Pub. Date: Feb. 1, 2024

(54) CROSS-CLUSTER GRAPH QUERIES

(71) Applicant: VMware, Inc., Palo Alto, CA (US)

(72) Inventors: Sripriya Venkatesh PRASAD, Bothell, WA (US); Deep P DESAI, Sammamish, WA (US)

(73) Assignee: VMware, Inc., Palo Alto, CA (US)

(21) Appl. No.: 17/875,106

(22) Filed: Jul. 27, 2022

(51) Int. Cl. G06F 16/901; G06F 16/25; G06F 16/28

(52) U.S. Cl. CPC G06F 16/9024; G06F 16/254; G06F 16/285

(57) ABSTRACT

Disclosed herein is a computer-implemented method for the ingestion of data into a partitioned database, the method comprising: receiving data at at least one ingestion node of a graph database, storing the data as a disjoint set of vertices, in a partitioned database, analyzing the disjoint set of vertices to find a set of remote edges and a set of native edges, and storing the set of remote edges and the set of native edges as a set of disjointed vertices in the partitioned database.

### BACKGROUND

Entity Data Service (EDS) is a distributed and highly scalable system which collects, stores and provides query capabilities for cloud assets. EDS supports graph exploration for cloud assets within a partition (for example, a cloud account for inventory data). However, there has been a growing need for the ability to explore graphs across partitions within a customer organization. This is primarily driven by the fact that there are asset connections that cross account boundary which are required for understanding the inventory data from a single pane of view.

When dealing with data in a partitioned database, searching for relationships across multiple partitions can be time consuming. Previous inventions do not allow for cross cluster, or cross partition, querying, which means that each partition must be individually queried for relationship data. Having support to perform cross cluster graph queries in EDS allows for graph query support across multiple partitions. This also enables the capability to provide infinite scale for storing and querying cloud assets for a very large cloud account.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating an embodiment of a system for ingestion of data into a partitioned database, and the query of the data, according to embodiments.

FIG. 2 is a block diagram illustrating an example ingestion node for data ingestion, in accordance with embodiments

FIG. 3 is a block diagram illustrating an example query system for querying the partitioned database, in accordance with embodiments.

FIG. 4 is a block diagram of an example computer system upon which embodiments of the present invention can be implemented.

FIG. 5 depicts a flow diagram for the ingestion of the data.

FIG. 6 depicts a flow diagram for querying multiple partitions of the graph database.

### DETAILED DESCRIPTION OF CERTAIN EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “transforming,” “storing,” “forwarding,” “deleting,” “aggregating,” “returning,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve cross partition, or cross cluster, querying by allowing the querying of multiple partitions at once rather than having to individually query each partition. By having to individually query partitions, it is much easier to lose track of data, and the process is time consuming. The ability to query across multiple partitions for remote relationships will save on time and energy.

In accordance with various embodiments, a computer-implemented method for ingestion, storage, and queering of data is described. At ingestion, the data is organized and stored as a set of disjointed vertices, and any native or remote edges are recognized and stored. A query may involve at least a source partition. In queries that involve remote partitions, the source partition is first searched for tier nodes and any remote edges. For the discovered remote edges, the remote partitions are queried in parallel. The results are then combined and displayed.

### Example System for Managing Time Series Data

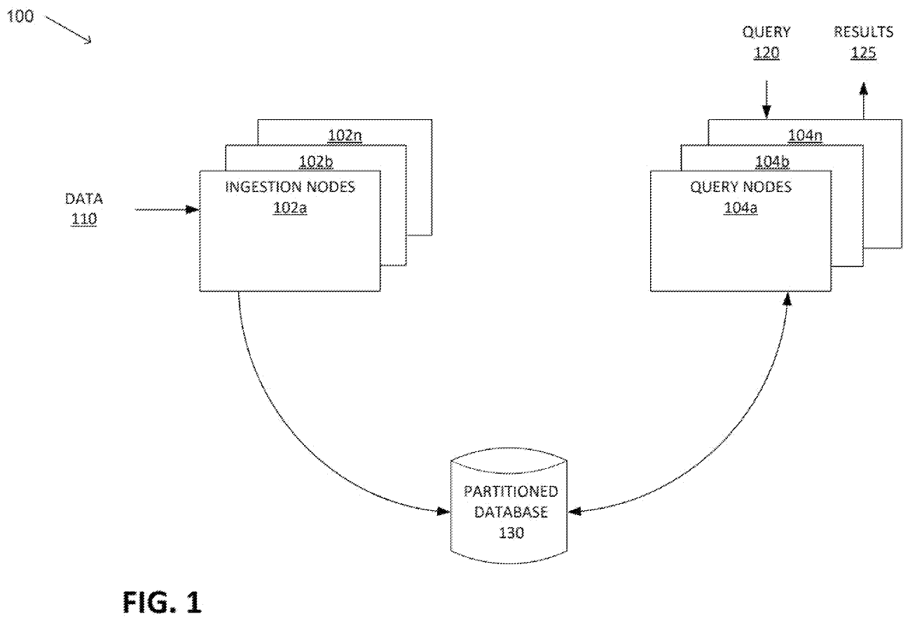

FIG. 1 is a block diagram illustrating an embodiment of a system 100 for ingestion of data 110 into a partitioned database 130, and the query 120 of the data 110, according to embodiments. System 100 is a distributed system including multiple ingestion nodes 102a through 102n (collectively referred to herein as ingestion nodes 102) and multiple query nodes 104a through 104n (collectively referred to herein as query nodes 104). Data 110 is received at ingestion nodes 102 and stored within the partitioned database 130. Query nodes 104 receive at least one query 120 for querying against partitioned database 130. Results 125 of query 120 are returned upon execution of query 120.

It should be appreciated that system 100 can include any number of ingestion nodes 102 and multiple query nodes 104. Ingestion nodes 102 and query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Data 110 is received at at least one ingestion node 102a through 102n. In some embodiments, data includes a numerical measurement of a system or activity that can be collected and stored as a metric (also referred to as a “stream”). For example, one type of metric is a CPU load measured over time. Other examples include, service uptime, memory usage, etc. It should be appreciated that metrics can be collected for any type of measurable performance of a system or activity. Operations can be performed on data points in a stream. In some instances, the operations can be performed in real time as data points are received. In other instances, the operations can be performed on historical data. Metrics analysis include a variety of use cases including online services (e.g., access to applications), software development, energy, Internet of Things (IoT), financial services (e.g., payment processing), healthcare, manufacturing, retail, operations management, and the like. It should be appreciated that the preceding examples are non-limiting, and that metrics analysis can be utilized in many different types of use cases and applications.

In accordance with some embodiments, a data point in a stream (e.g., in a metric) includes a name, a source, a value, and a time stamp. Optionally, a data point can include one or more tags (e.g., point tags). For example, a data point for a metric may include:
A name—the name of the metric (e.g., CPU_idle, service.uptime)
A source—the name of an application, host, container, instance, or other entity generating the metric (e.g., web_server_1, app1, app2)
A value—the value of the metric (e.g., 99% idle, 1000, 2000)
A timestamp—the timestamp of the metric (e.g., 1418436586000)
One or more point tags (optional)—custom metadata associated with the metric (e.g., location=las_vegas, environment=prod)

Ingestion nodes 102 are configured to process received data points of data 110 for persistence and indexing. In some embodiments, ingestion nodes 102 forward the data points of data 110 to partitioned database 130 for storage. In some embodiments, the data points of data 110 are transmitted to an intermediate buffer for handling the storage of the data points at partitioned database 130. In one embodiment, partitioned database 130 can store and output data, e.g., D1, D2, D3, etc. The data can include data 110, which may be discrete or continuous. For example, the data can include live data fed to a discrete stream, e.g., for a standing query. Continuous sources can include analog output representing a value as a function of time. With respect to processing operations, continuous data may be time sensitive, e.g., reacting to a declared time at which a unit of stream processing is attempted, or a constant, e.g., a signal. Discrete streams can be provided to the processing operations in timestamp order. It should be appreciated that the data 110 may be queried in real-time (e.g., by accessing the live data stream) or offline processing (e.g., by accessing the stored data).

In one embodiment, partitioned database 130 has at least two separate accounts that form the partitions. In one embodiment, partitioned database 130 may utilize a graphical database to store edges and vertices (for example, Amazon Neptune), a document database that can keep track of the edges and vertices, and how they have changed over time (for example, Amazon DynamoDB), and a system to provide search capabilities (for example, Elasticsearch Service).

In one embodiment, a vertex within the stored vertices comprises a list of searchable properties. A vertex may also be referred to as an entity. In one embodiment, an edge is a relationship between two vertices. Edges may be formed between vertices within the same partition of the partitioned database and are referred to as native edges. Native edges and their vertices can be displayed on a single graph. Remote edges are edges formed between two vertices that belong to different partitions of the partitioned database, and therefore are unable to be displayed on the same graph.

In accordance with various embodiments, received data points of data 110 also have an associated input observability format, also referred to herein as “observability atoms.” In some embodiments, the configuration rules of the data 110 monitoring system define operations for the transforming the data points from the input observability atom to the output observability atom. In some embodiments, the configuration rules identify input data 110 necessitating transformation to the output observability atom. In some embodiments, the input observability atom is one of a metric, a counter, a histogram, and a span. In some embodiments, wherein the output observability atom is one of a counter and a histogram.

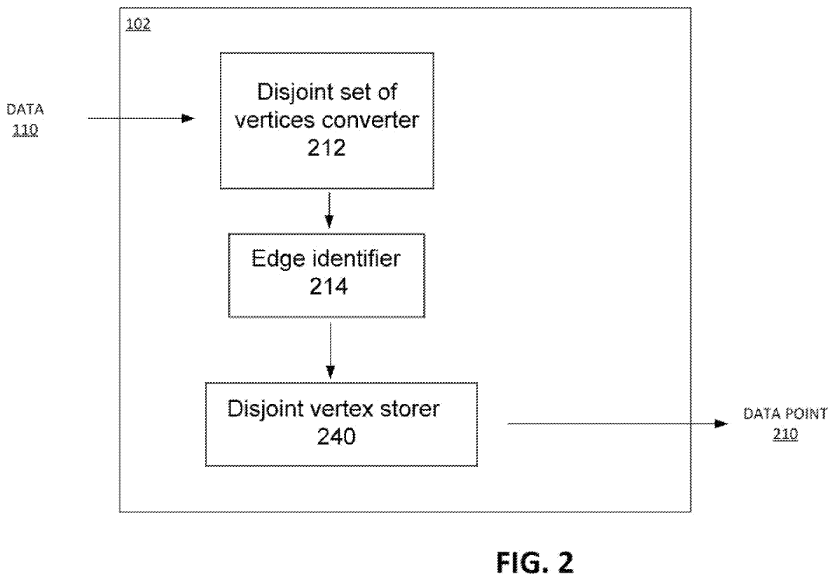

FIG. 2 is a block diagram illustrating an example ingestion node 102 (e.g., one of ingestion nodes 102a through 102n of FIG. 1) for data 110 ingestion, in accordance with embodiments. In one embodiment, ingestion node 102 receives data 110 (e.g., as data points), converts the data 110 into a disjoint set of vertices, determines the remote edges and the native edges of the data 110, and then stores the native and remote edges as disjoint vertices. Ingestion node 102 includes Disjoint set of vertices converter 212, edge identifier 214, disjoint vertex storer 240, and data point 210. It should be appreciated that ingestion node 102 is one node of a plurality of ingestion nodes of a distributed system for managing time series data (e.g., system 100).

In the example shown in FIG. 2, data 110 including data points is received. In one embodiment, data 110 including data points is received from an application or system. Data 110 is received at the disjoint set of vertices converter 212. Disjoint set of vertices converter 212 is configured to convert the data 110 into a set of disjoint vertices that are compatible with the graph database. Next, the data is analyzed by edge identifier 214 to determine the edges, or relationships, between vertices.

The edges may be either native edges, where both vertices are from the same partition of the partitioned database, or remote edges, where the connected vertices are from different partitions of the partitioned database. In the case of native edges, edge information is stores with the disjoint vertices and can be displayed in a graph. In the case of remote edges, a separate vertex, or node, is created to store the edge information. This separate vertex will not be displayed graphically but is only used to store the information that a remote edge is present. This separate vertex will be created in all the relevant partitions of the partitioned database.

After the edges have been identified, the data is stored by disjoint vertex storer 240. Disjoint vertex storer will store the data in the appropriate partitions of partitioned database 130 as data point 210.

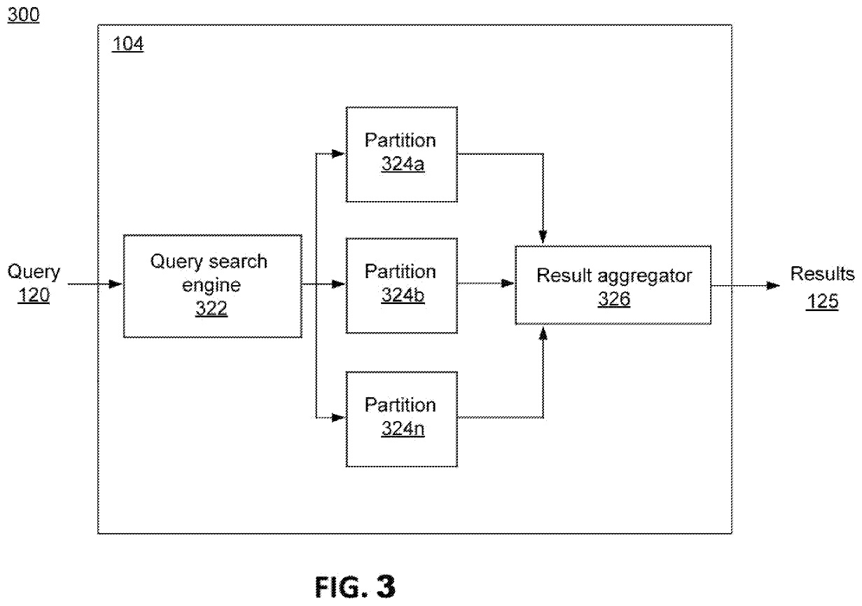

FIG. 3 is a block diagram illustrating an example query system 300 for querying the partitioned database 130, in accordance with embodiments. System 300 is a distributed system including multiple query nodes or processors 104a through 104n (collectively referred to herein as ingestion nodes or processors 104), a query service engine 322 that sends the query through at least one partition (324a, 324b, to 324n, etc.) of the partitioned database 130, and a result aggregator 326. System 300 has an input of a query 120, and an output of results 125. Query search engine 310 may be implemented within and distributed over one or more query nodes (e.g., query nodes 104a through 104n of FIG. 1).

It should be appreciated that system 300 can receive data from any number of ingestion nodes 102. Ingestion nodes 102 and the query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

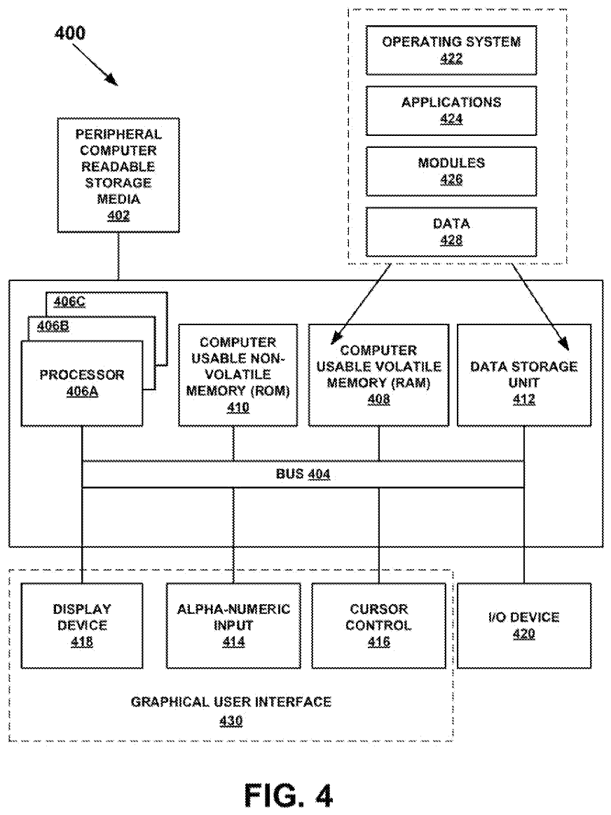

FIG. 4 is a block diagram of an example computer system 400 upon which embodiments of the present invention can be implemented. FIG. 4 illustrates one example of a type of computer system 400 (e.g., a computer system) that can be used in accordance with or to implement various embodiments which are discussed herein.

It is appreciated that computer system 400 of FIG. 4 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 400 of FIG. 4 is well adapted to having peripheral tangible computer-readable storage media 402 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 400 of FIG. 4 includes an address/data bus 404 for communicating information, and a processor 406A coupled with bus 404 for processing information and instructions. As depicted in FIG. 4, computer system 400 is also well suited to a multi-processor environment in which a plurality of processors 406A, 406B, and 406C are present. Conversely, computer system 400 is also well suited to having a single processor such as, for example, processor 406A. Processors 406A, 406B, and 406C may be any of various types of microprocessors. Computer system 400 also includes data storage features such as a computer usable volatile memory 408, e.g., random access memory (RAM), coupled with bus 404 for storing information and instructions for processors 406A, 406B, and 406C. Computer system 400 also includes computer usable non-volatile memory 410, e.g., read only memory (ROM), coupled with bus 404 for storing static information and instructions for processors 406A, 406B, and 406C. Also present in computer system 400 is a data storage unit 412 (e.g., a magnetic or optical disc and disc drive) coupled with bus 404 for storing information and instructions. Computer system 400 also includes an alphanumeric input device 414 including alphanumeric and function keys coupled with bus 404 for communicating information and command selections to processor 406A or processors 406A, 406B, and 406C. Computer system 400 also includes an cursor control device 416 coupled with bus 404 for communicating user input information and command selections to processor 406A or processors 406A, 406B, and 406C. In one embodiment, computer system 400 also includes a display device 418 coupled with bus 404 for displaying information.

Referring still to FIG. 4, display device 418 of FIG. 4 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 416 allows the computer user to dynamically signal the movement of a visible symbol (cursor) on a display screen of display device 418 and indicate user selections of selectable items displayed on display device 418. Many implementations of cursor control device 416 are known in the art including a trackball, mouse, touch pad, touch screen, joystick or special keys on alphanumeric input device 414 capable of signaling movement of a given direction or manner of displacement. Alternatively, it will be appreciated that a cursor can be directed and/or activated via input from alphanumeric input device 414 using special keys and key sequence commands. Computer system 400 is also well suited to having a cursor directed by other means such as, for example, voice commands. In various embodiments, alphanumeric input device 414, cursor control device 416, and display device 418, or any combination thereof (e.g., user interface selection devices), may collectively operate to provide a graphical user interface (GUI) 430 under the direction of a processor (e.g., processor 406A or processors 406A, 406B, and 406C). GUI 430 allows user to interact with computer system 400 through graphical representations presented on display device 418 by interacting with alphanumeric input device 414 and/or cursor control device 416.

Computer system 400 also includes an I/O device 420 for coupling computer system 400 with external entities. For example, in one embodiment, I/O device 420 is a modem for enabling wired or wireless communications between computer system 400 and an external network such as, but not limited to, the Internet. In one embodiment, I/O device 420 includes a transmitter. Computer system 400 may communicate with a network by transmitting data via I/O device 420.

Referring still to FIG. 4, various other components are depicted for computer system 400. Specifically, when present, an operating system 422, applications 424, modules 426, and data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, computer-readable storage media within data storage unit 412, peripheral computer-readable storage media 402, and/or other tangible computer-readable storage media.

### Example Methods of Operation

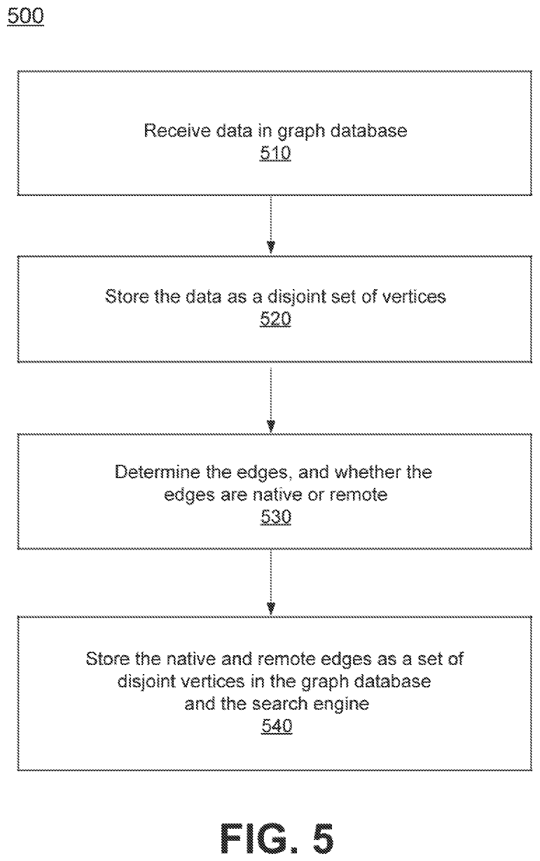

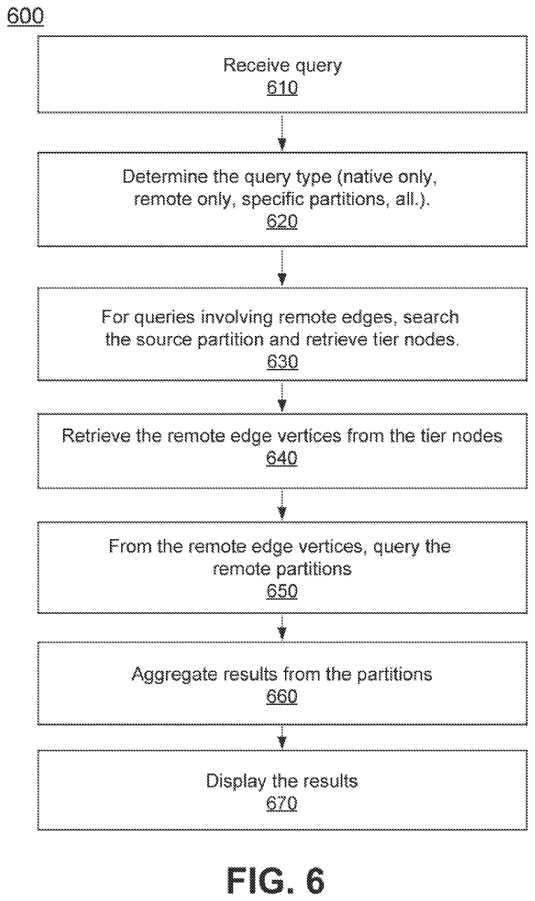

The following discussion sets forth in detail the operation of some example methods of operation of embodiments. With reference to FIGS. 5 through 6, flow diagrams 500 and 600 illustrate example procedures used by various embodiments. The flow diagrams 500 and 600 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 400). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagrams 500 and 600 may be performed in an order different than presented and/or not all of the procedures described in flow diagrams 500 and 600 may be performed. It is further appreciated that procedures described in flow diagrams 500 and 600 may be implemented in hardware, or a combination of hardware with firmware and/or software provided by computer system 400.

FIG. 5 depicts a flow diagram 500 for the ingestion of the data 110. At procedure 510, data is received by the graph database. This may happen on a single ingestion node 102, or multiple. In one embodiment, data is received from an API request which is exposed from an EDS. The API request is validated before ingestion.

At procedure 520, the received data is converted to a set of disjointed vertices, and stored as such. In one embodiment, the disjointed vertices data is also stored in the document database. At procedure 530, the graph database analyzes the data to determine the edges, and whether the edges are remote edges or native edges. At procedure 540, the native and remote edges are stored as a set of disjoint vertices in the graph database, and in one embodiment the document database and search engine. For native edges, the edge and relationship data are stored with the relevant vertices, and can later be displayed together in a single graph. For remote edges, a separate vertex is made in each of the relevant partitions of the partitioned database. This separate vertex contains the data that there is an edge between the remote vertices.

FIG. 6 depicts a flow diagram 600 for querying multiple partitions of the graph database. In one embodiment, if a consistent read is not required then the search service or document database are queried to assist in performance.

At procedure 610, the query is received by the search engine. At procedure 620, the type of query is determined. There are multiple forms that a query can take, such as querying for native edges only, querying for remote edges only, querying remote edges from specific partitions, or querying for all edges. In one embodiment, the remote vertices may also be queried.

Should the query involve any remote edges, procedure 630 shows the source partition being searched first, and the tire nodes retrieved. From the tier nodes, the vertices that involve remote edges may be discovered. In one embodiment, a tier node is a vertex with edge information. As the remote edge vertices contain information about the edge and vertices, the partition to which the second vertex of the remote edge belongs to can be discovered. At procedure 650, the remote partitions are then queried, and remote vertex information is retrieved. In one embodiment remote partitions are queried in parallel. The remote partition queries are structured as separate queries. Because of this structure, at procedure 660 the results of the multiple remote partition queries are aggregated into a single result. At procedure 670 the single result is displayed.

In one embodiment, the aggregated result is a list of all the discovered edges. In one embodiment, the aggregated result is a tree diagram response. This diagram also includes the roots and child nodes. In this embodiment, the search engine needs to maintain information from the source partition query, as well as the remote partition query.

In one embodiment, the tree diagram response may involve overlapping trees. In this embodiment, the search and results would be done on a tier-by-tier basis in order to properly show the relationships.

It should be understood that other search result merger strategies may be applicable to the present invention depending on the query type, and that the listed merging methods are not intended to be limiting.

In one embodiment, remote connections can be queried directly from a disjoint set. In one embodiment, edges are dynamically discovered.

It is noted that any of the procedures, stated above, regarding the flow diagrams of FIGS. 5 through 6 may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer-implemented method for the ingestion of data into a partitioned database, the method comprising:
receiving data at at least one ingestion node of a graph database;
storing the data as a disjoint set of vertices, in a partitioned database;
analyzing the disjoint set of vertices to find a set of remote edges and a set of native edges; and
storing the set of remote edges and the set of native edges as a set of disjointed vertices in the partitioned database.

2. The computer implemented method of claim 1, wherein the method further comprises:
receiving the data from the at least one ingestion node, wherein the data is collected and stored as a stream.

3. The computer implemented method of claim 2 wherein, the data is a central processing unit (CPU) load measured over time.

4. The computer implemented method of claim 1, wherein said receiving data at said at least one ingestion node further comprises:
receiving data pertaining to operations performed on data points in a stream.

5. The computer implemented method of claim 1, wherein receiving the data at the at at least one ingestion node further comprises:
receiving data pertaining to a variety of use cases selected from the group consisting of online services, software development, energy, internet of things, financial services, healthcare, manufacturing, retail, and operations management.

6. The computer implemented method of claim 2, wherein the operations performed on the data in the stream further comprises:
a data point in the stream selected from the group consisting of a name, a source, a value, and a time stamp.

7. A computer-implemented method querying multiple partitions of a partitioned database, the method comprising:
receiving a query in a search engine, wherein the query comprises at least a request for remote edges;
searching a source partition and retrieving at least one tier node;
querying at least one remote partition, and receiving at least one result; and
aggregating the at least one result from at the at least one remote partition into a single result.

8. The computer-implemented method of claim 7 wherein, a graphical database is queried.

9. The computer-implemented method of claim 7 wherein, a document database is queried.

10. The computer-implemented method of claim 7 wherein, a search service is queried.

11. The computer-implemented method of claim 7 wherein, the query further comprises:
a request for remote vertices.

12. A non-transitory computer readable storage medium having computer readable program code stored thereon for causing a computer system to perform a method for the ingestion of data into a partitioned database and querying multiple partitions of the partitioned database, the method comprising:
receiving data at at least one ingestion node of a graph database;
storing the data as a disjoint set of vertices, in a partitioned database;
analyzing the disjoint set of vertices to find a set of remote edges and a set of native edges;
storing the set of remote edges and the set of native edges as a set of disjointed vertices in the partitioned database;
receiving a query in a search engine, wherein the query comprises at least a request for remote edges;
searching a source partition and retrieving at least one tier node;
querying at least one remote partition, and receiving at least one result; and
aggregating the at least one result from at the at least one remote partition into a single result.

13. The non-transitory computer readable storage medium of claim 12, wherein the method further comprises:
receiving the data from the at least one ingestion node, wherein the data is collected and stored as a stream.

14. The non-transitory computer readable storage medium of claim 13 wherein, the data is a central processing unit (CPU) load measured over time.

15. The non-transitory computer readable storage medium of claim 12, wherein said receiving data at said at least one ingestion node further comprises:
receiving data pertaining to operations performed on data points in a stream.

16. The non-transitory computer readable storage medium of claim 12, wherein receiving the data at the at at least one ingestion node further comprises:
receiving data pertaining to a variety of use cases selected from the group consisting of online services, software development, energy, internet of things, financial services, healthcare, manufacturing, retail, and operations management.

17. The non-transitory computer readable storage medium of claim 13, wherein the operations performed on the data in the stream further comprises:
a data point in the stream selected from the group consisting of a name, a source, a value, and a time stamp.

18. The non-transitory computer readable storage medium of claim 12, wherein the query further comprises:
a request for remote vertices.

19. The non-transitory computer readable storage medium of claim 7 wherein, the query is performed selected from the group consisting of a graphical database, document database, and a search service.
